(19) United States
(12) Patent Application Publication
(10) Pub. No.: US 2026/0004233 A1
(43) Pub. Date: Jan. 1, 2026

(54) TRACKING PALLET GOODS WITH PASSIVE TAGS

(71) Applicant: Hubble Network Inc., Seattle, WA (US)

(72) Inventor: Ben Juda WILD, Bee Cave, TX (US)

(21) Appl. No.: 19/238,304

(22) Filed: Jun. 13, 2025

Related U.S. Application Data
(60) Provisional application No. 63/666,089, filed on Jun. 28, 2024.

(51) Int. Cl. G06Q 10/087; G06K 7/10

(52) U.S. Cl. CPC G06Q 10/087; G06K 7/10366

(57) ABSTRACT

To track pallet goods with passive tags, a passive tag is secured to the goods and a mobile tracking device is secured to a pallet that supports the goods. The mobile tracking device transmits an RF (radiofrequency) signal that is received at the passive tag. In response to the RF signal, the passive tag transmits a response message including information (e.g., from an onboard sensor of the passive tag). The mobile tracking device receives the response message including the information and transmits the information to a network (e.g., a wireless personal area network (WPAN, (e.g., Bluetooth, BLE, etc.)), a wireless local area network (WLAN, (e.g., Wi-Fi, etc.)), a cellular network, a satellite network, etc.).

### CROSS-REFERENCE TO RELATED APPLICATION

This application claims priority to U.S. Provisional Patent Application Ser. No. 63/666,089, filed on Jun. 28, 2024, the entire contents of which are hereby incorporated by reference as if fully set forth.

### BACKGROUND

A pallet (also called a skid) is a flat transport structure for supporting goods. Pallets are typically used to support goods as they are transported through the global supply chain.

### BRIEF DESCRIPTION OF DRAWINGS

Various embodiments in accordance with the present disclosure will be described with reference to the drawings, in which:

FIG. 1 is a functional block diagram illustrating a system for tracking pallet goods with passive tags according to some embodiments;

FIG. 2 is a functional block diagram illustrating a passive tag according to some embodiments;

FIG. 3 is a functional block diagram illustrating a mobile tracking device according to some embodiments; and

FIG. 4 is a flow diagram illustrating operations of a method for tracking pallet goods with passive tags according to some embodiments; and

FIG. 5 is a flow diagram illustrating operations of another method for tracking pallet goods with passive tags according to some embodiments.

### DETAILED DESCRIPTION

The present disclosure relates to tracking goods as they move through the global supply chain. According to some embodiments, a passive tag is secured to the goods, and a mobile tracking device is secured to a pallet that supports the goods. The mobile tracking device transmits an RF (radiofrequency) signal that is received at the passive tag. In response to the RF signal, the passive tag transmits a response message including information (e.g., from an onboard sensor of the passive tag). The mobile tracking device receives the response message including the information and transmits the information to a network (e.g., a wireless personal area network (WPAN, (e.g., Bluetooth, BLE (Bluetooth Low Energy), etc.)), a wireless local area network (WLAN, (e.g., Wi-Fi, etc.)), a cellular network, a satellite network, etc.).

In the global supply chain, there are benefits to tracking pallets, and also benefits to tracking the goods on the pallets. Pallets are sometimes tracked using mobile tracking devices, such as GPS (Global Positioning System) trackers. It is not economically feasible, however, to secure a GPS tracker to all goods on the pallet due to the high cost of such trackers. Some of the present embodiments solve this problem by leveraging passive tags, which are less expensive than mobile tracking devices. Passive tags, such as passive RFID tags, can be secured to goods on a pallet at much lower cost than securing GPS trackers to the goods. Information can be collected from the passive tags by transmitting an RF signal from a mobile tracking device secured to the pallet. The passive tags receive the RF signal from the mobile tracking device and transmit response messages, which are received at the mobile tracking device. The mobile tracking device then transmits the information from the passive tags to a network (e.g., a wireless personal area network (WPAN, (e.g., Bluetooth, BLE, etc.)), a wireless local area network (WLAN, (e.g., Wi-Fi, etc.)), a cellular network, a satellite network, etc.). Since the transmit range of passive tags is generally very limited (e.g., 5 m), the location of the goods associated with a given passive tag can be inferred from the location of the mobile tracking device. And, since the passive tags are much less expensive than the mobile tracking device, the present embodiments enable low-cost tracking of goods on pallets without having to attach mobile tracking devices to each of the goods on the pallet.

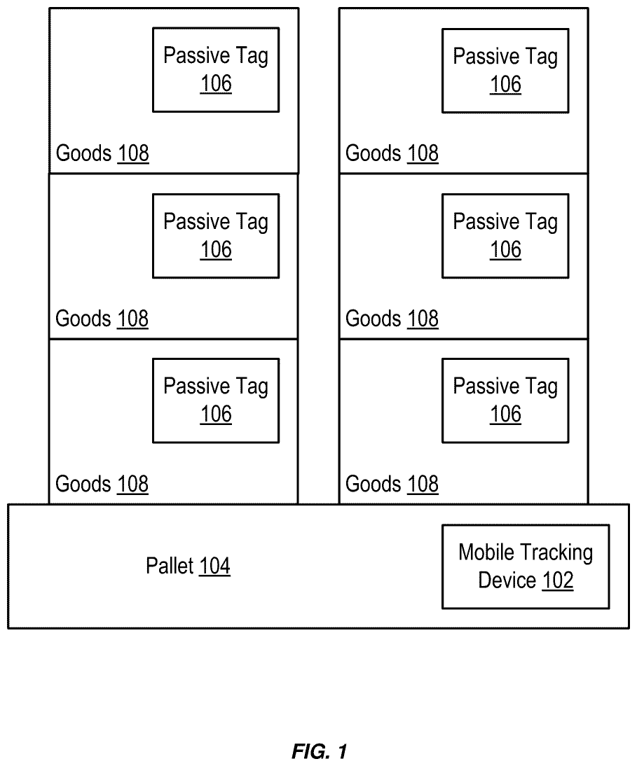

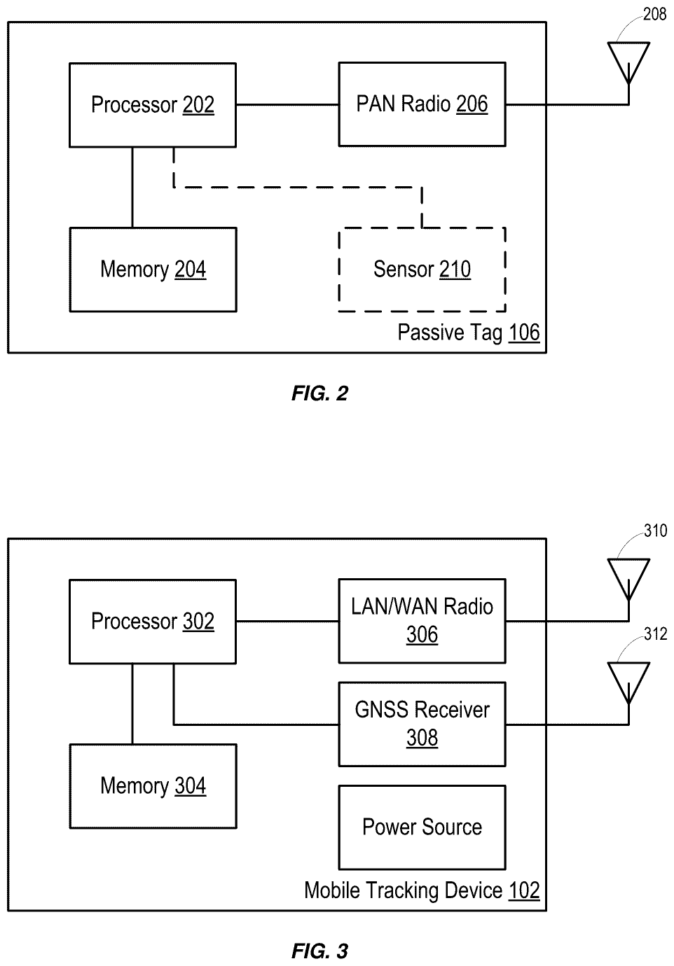

With reference to FIG. 1, some of the present embodiments include a mobile tracking device 102 secured to a pallet 104 and one or more passive tags 106 secured to goods 108 on the pallet 104. A non-limiting example of the passive tag 106 is described below and illustrated in FIG. 2, and a non-limiting example of the mobile tracking device 102 is described below and illustrated in FIG. 3. Generally, however, the mobile tracking device 102 includes a power source (e.g., a battery), hardware for communicating with the passive tag(s) 106, and hardware and software for communicating with a network. The passive tag 106, by contrast, does not include a power source. Instead, the passive tag 106 includes hardware for generating power from an RF signal received from the mobile tracking device 102 and hardware and software for communicating with the mobile tracking device 102.

In some embodiments, the mobile tracking device 102 secured to the pallet 104 periodically acts as a gateway to the passive tag(s) 106 secured to the goods 108 on the pallet 104. For example, the mobile tracking device 102 may send an RF (radiofrequency) signal to power or charge the passive tag(s) 106, and the mobile tracking device 102 then listens for response messages from the passive tag(s) 106. When the mobile tracking device 102 receives one or more response messages from the passive tags 106, it relays information in the response message(s) to one or more networks (e.g., a wireless personal area network (WPAN, (e.g., Bluetooth, BLE, etc.)), a wireless local area network (WLAN, (e.g., Wi-Fi, etc.)), a cellular network, a satellite network, etc.). The information that the passive tag 106 sends to the mobile tracking device 102, and which the mobile tracking device 102 sends to the network(s), may include, for example, an identifier of the passive tag 106. In some embodiments, the information may also include sensor data, such as temperature information. When the identifier of the passive tag 106 is received by the network, the location of the goods 108 associated with that passive tag 106 can be inferred from the location of the mobile tracking device 102 that transmitted that identifier to the network. In various embodiments, and as discussed further below, the location of the mobile tracking device 102 may be determined using GPS, BLE beacons, Wi-Fi sniffing, or any other applicable technique.

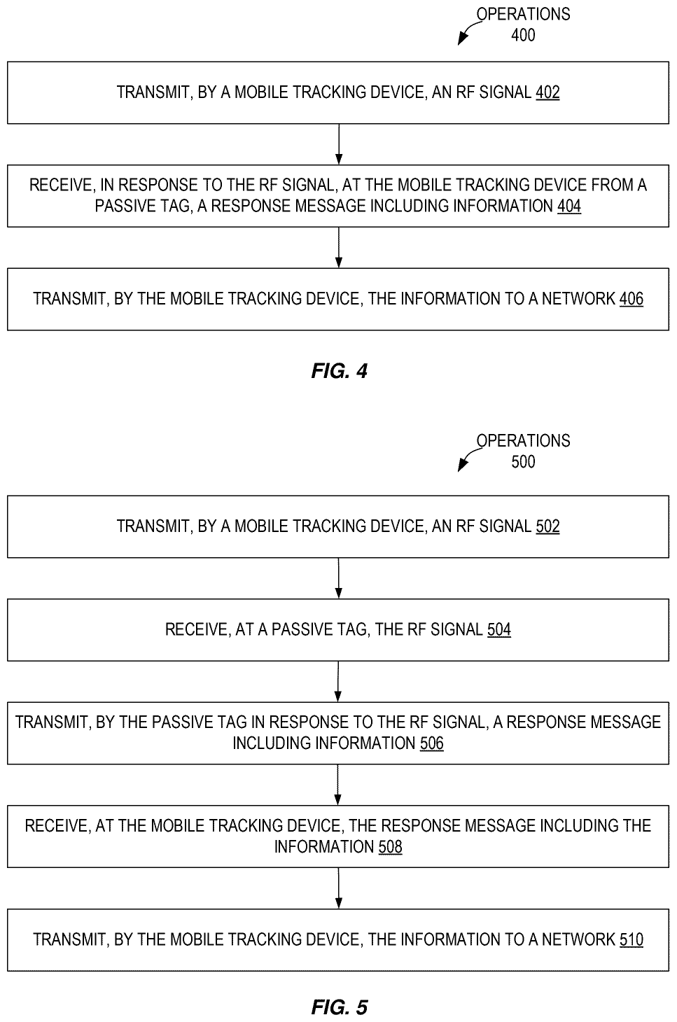

FIG. 2 illustrates a non-limiting example of the passive tag 106 according to some embodiments. As shown, the passive tag 106 includes at least one processor 202, memory 204, a radio 206, and an antenna 208. In some embodiments, the processor 202 may be an integrated circuit (IC), also known as a microchip, computer chip, or simply chip. An IC is a small electronic device made up of multiple interconnected electronic components, such as transistors, resistors, and capacitors. These components are etched onto a small piece of semiconductor material, such as silicon, and are configured to perform functions including processing and storing information. In various embodiments, however, the processor 202 can be any suitable processor(s) capable of executing instructions. For example, in various examples, the processor(s) 202 can be general-purpose or embedded processors implementing any of a variety of instruction set architectures (ISAs), such as the x86, ARM, PowerPC, SPARC, or MIPS ISAs, or any other suitable ISA. The memory 204 can store instructions and data accessible by the processor 202. In some embodiments, the memory 204 is nonvolatile/Flash-type memory, since the passive tag 106 does not include an internal power supply. However, in various examples the memory 204 can be implemented using any suitable memory technology, such as random-access memory (RAM), static RAM (SRAM), synchronous dynamic RAM (SDRAM), nonvolatile/Flash-type memory, or any other type of memory. In various embodiments, the memory 204 stores instructions executable by the processor 202 to perform aspects of the methods described herein, including without limitation the methods described with respect to FIGS. 4 and 5.

As discussed above, in some embodiments the passive tag 106 does not include an internal power supply. Instead, the passive tag 106 generates power via an RF signal received from the mobile tracking device 102, as further described below. In some embodiments, however, the passive tag 106 may include an internal power supply, such as a capacitor or a battery, that is capable of maintaining a charge for a short duration upon receiving the RF signal from the mobile tracking device 102. In further embodiments, the passive tag 106 may include an internal power supply that is capable of maintaining a charge for longer durations, such as weeks or months, and in such embodiments the passive tag 106 may not be passive at all, and may instead be simply a tag.

With further reference to FIG. 2, the passive tag 106 further includes one or more radios 206 communicatively coupled with the processor 202, each of which includes a corresponding antenna 208. For example, the illustrated embodiment of the passive tag 106 includes a PAN (personal area network) radio 206 and a corresponding PAN radio antenna 208 that enables the passive tag 106 to communicate wirelessly with a PAN using, for example, Bluetooth or BLE (Bluetooth Low Energy) technology. The PAN radio 206 may include a transmitter and a receiver (or a transceiver) that enable two-way communication with the PAN.

In some embodiments, the passive tag 106 may provide sensing functionality, and thus may further include one or more sensors 210 communicatively coupled with the processor 202. In various embodiments, the onboard sensor 210 may be configured to sense any of a variety of conditions. For example, in non-limiting examples, the sensor 210 may sense ambient temperature or humidity, or detect the presence and/or concentration of gaseous substances (e.g., CO, CO₂, O₂, etc.) or particulate matter (e.g., dust, dirt, soot, smoke, etc.).

In some embodiments, the passive tag may comprise a passive RFID (radio-frequency identification) tag. Passive RFID is a term used to describe RFID tags that do not have a battery or other internal power source. Instead of a battery, passive RFID tags rely on the energy received from the RFID reader and its antenna for power. When the RFID reader scans the area for RFID tags, it sends out an electrical signal, which is converted into electromagnetic RF energy by the RFID antenna, and that energy is used to power the RFID tag in the read area. RFID tags need a very small amount of energy to power their internal RFID chip and send a response with the programmed information. Because passive RFID is a battery-free technology, the tags will never be reliant on battery power or restricted by the short lifespan of a small battery. Additionally, passive RFID tags can be purchased for a very low cost-only a few cents for UHF RFID tags, which wouldn't be possible if a battery was included in the tag.

RFID readers automatically switch between frequencies within a certain range to pick up RFID tag responses on all available frequencies. There are three main frequency ranges used by passive RFID systems-Low Frequency, High Frequency, and Ultra-High Frequency. Low Frequency (LF) RFID is emitted in the 30-300 kHz range. High Frequency (HF) RFID is emitted in the 3-30 MHz range. Near-Field Communication, or NFC, is a type of High Frequency RFID. Ultra-High Frequency (UHF) RFID is emitted between 300 MHz and 3 GHz. The maximum read distance for passive RFID systems allows the frequency ranges to be grouped into two groups-long-range RFID and short-range RFID. UHF RFID is the only frequency that fits into the long-range RFID group, while HF/NFC and LF make up the short-range RFID group. Passive UHF RFID tags can generally be read on average about 20-30 feet in distance, depending on the tag size and environment. Passive HF/NFC RFID tags can generally be read on average about 6 inches away, and passive LF RFID tags can only be read at a maximum of 2-3 inches away.

To communicate with the passive RFID tag, the RFID reader transmits an RF signal from its antenna and the propagated waves travel in space to a distance vertically and horizontally based on the specific gain and beamwidth parameters of the antenna. The passive RFID tag in the field receives the energy, or RF waves, using its own antenna. The energy received travels through the passive RFID tag's antenna, and a portion of it is used to activate the IC and prepare for transmission of data. In some instances, the RF signal from the RFID reader is unmodulated, while in other instances the RF signal is modulated and the data to be transmitted by the passive RFID tag is based on commands received from the RFID reader in the modulated RF signal.

In the passive RFID tag, when the IC is turned on it modulates the energy received via the RF signal with the information stored in the tag and reflects the remaining energy back. This information could be, for example, EPC (Electronic Product Code) memory, user memory, or anything programmed on the tag. This reflection of energy back to the RFID reader is known as backscatter radiation. The backscatter radiation travels through the air, into the RFID reader antenna's field, and to a decoding circuit to recover the tag's information. In some embodiments, the passive tag 106 may not use backscatter radiation, but may instead first harvest energy from the RF signal from the tracking device to charge an internal power supply (e.g., a capacitor) and then actively transmit a radio message using the stored charge. In some embodiments, the radio message may be sent using a standard protocol such as BLE.

FIG. 3 illustrates a non-limiting example of the mobile tracking device 102 according to some embodiments. As shown, the mobile tracking device 102 includes at least one processor 302 and memory 304. The processor(s) 302 can be any suitable processor(s) 302 capable of executing instructions. For example, in various examples, the processor(s) 302 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 302 can commonly, but not necessarily, implement the same ISA. The memory 304 can store instructions and data accessible by the processor(s) 302. In various examples, the memory 304 can be implemented using any suitable memory technology, such as random-access memory (RAM), static RAM (SRAM), synchronous dynamic RAM (SDRAM), nonvolatile/Flash-type memory, or any other type of memory. In various embodiments, the memory 304 stores instructions executable by the processor(s) 302 to perform aspects of the methods described herein, including without limitation the methods described with respect to FIGS. 4 and 5.

The mobile tracking device 102 further includes one or more radios 306 and one or more receivers 308, each of which is communicatively coupled with the processor 302, and each of which includes a corresponding antenna 310, 312. For example, the mobile tracking device 102 may include one or more of a satellite radio and a corresponding satellite radio antenna that enable the mobile tracking device 102 to communicate wirelessly with a satellite network, a PAN (personal area network) radio 306 and a corresponding PAN radio antenna that enable the mobile tracking device 102 to communicate wirelessly with a PAN using, for example, Bluetooth or BLE (Bluetooth Low Energy) technology, a LAN/WAN (local area network/wide area network) radio 306 and a corresponding LAN/WAN radio antenna 310 that enable the mobile tracking device 102 to communicate wirelessly with a LAN and/or a WAN, such as, for example, a WiFi network or a cellular network. The mobile tracking device 102 may further include a GNSS (global navigation satellite system (e.g., GPS)) receiver 308 and a corresponding GNSS receiver antenna 312 that enable the mobile tracking device 102 to receive wireless transmissions from a GNSS. Any of the radios described above may include a transmitter and a receiver (or a transceiver) that enable two-way communication with the respective networks. In alternative embodiments, one or more of the described radios/antennas may be omitted. In some embodiments, one or more of the radios may be combined into a single radio that can communicate over multiple networks. For example, in some embodiments the satellite radio may be combined with the PAN radio. In some embodiments, one or more of the antennas may be omnidirectional, while in some embodiments one or more of the antennas may have directional characteristics. For example, the satellite radio antenna and the GNSS receiver antenna 312 may have respective radiation patterns with one or more lobes or beams.

FIG. 4 is a flow diagram illustrating operations 400 of a method for tracking pallet goods with passive tags according to some examples. Some or all of the operations 400 (or other processes described herein, or variations, and/or combinations thereof) are performed under the control of one or more computer systems (e.g., the mobile tracking device 102) configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 400 are performed by the mobile tracking device 102 and/or the passive tag 106 of the other figures.

The operations 400 include, at block 402, transmitting, by a mobile tracking device, an RF signal. For example, the mobile tracking device 102 of FIG. 3 may transmit the RF signal. The operations 400 further include, at block 404, receiving, in response to the RF signal, at the mobile tracking device from a passive tag, a response message including information. For example, the mobile tracking device 102 of FIG. 3 may receive the response message including the information from the passive tag 106 of FIG. 2. In various embodiments, the information may include the information described above with reference to FIG. 2. The operations 400 further include, at block 406, transmitting, by the mobile tracking device, the information to a network. For example, the mobile tracking device 102 of FIG. 3 may transmit the information to any of the networks described above using any of the radios and antennas described above with reference to FIG. 3.

FIG. 5 is a flow diagram illustrating operations 500 of another method for tracking pallet goods with passive tags according to some examples. Some or all of the operations 500 (or other processes described herein, or variations, and/or combinations thereof) are performed under the control of one or more computer systems (e.g., the mobile tracking device 102) configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 500 are performed by the mobile tracking device 102 and/or the passive tag 106 of the other figures.

The operations 500 include, at block 502, transmitting, by a mobile tracking device, an RF signal. For example, the mobile tracking device 102 of FIG. 3 may transmit the RF signal. The operations 500 further include, at block 504, receiving, at a passive tag, the RF signal. For example, the passive tag 106 of FIG. 2 may receive the RF signal. The operations 500 further include, at block 506, transmitting, by the passive tag in response to the RF signal, a response message including information. For example, the passive tag 106 of FIG. 2 may transmit the response message including the information. The operations 500 further include, at block 508, receiving, at the mobile tracking device, the response message including the information. For example, the mobile tracking device 102 of FIG. 3 may receive the response message including the information from the passive tag 106 of FIG. 2. The operations 500 further include, at block 510, transmitting, by the mobile tracking device, the information to a network. For example, the mobile tracking device 102 of FIG. 3 may transmit the information to any of the networks described above using any of the radios and antennas described above with reference to FIG. 3.

As described above, the mobile tracking device 102 transmits an RF signal that is received by the passive tag 106, and the passive tag 106 responds by sending information back to the mobile tracking device 102. The mobile tracking device 102 thus performs functions, in some embodiments, that are typical of an RFID reader. The present embodiments differ, however, from typical RFID readers because the mobile tracking device 102 is mobile and battery-powered. By contrast, RFID readers are typically powered by AC mains because they are power-hungry devices, and RFID readers are therefore typically in fixed locations.

In the preceding description, various embodiments are described. For purposes of explanation, specific configurations and details are set forth in order to provide a thorough understanding of the embodiments. However, it will also be apparent to one skilled in the art that the embodiments can be practiced without the specific details. Furthermore, well-known features can be omitted or simplified in order not to obscure the embodiment being described.

Bracketed text and blocks with dashed borders (e.g., large dashes, small dashes, dot-dash, and dots) are used herein to illustrate optional aspects that add additional features to some embodiments. However, such notation should not be taken to mean that these are the only options or optional operations, and/or that blocks with solid borders are not optional in certain embodiments.

References to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is within the knowledge of one skilled in the art to affect such feature, structure, or characteristic in connection with other embodiments whether or not explicitly described.

Moreover, in the various embodiments described above, unless specifically noted otherwise, disjunctive language such as the phrase “at least one of A, B, or C” is intended to be understood to mean any of A, B, or C, or any combination thereof (e.g., A, B, and/or C). Similarly, language such as “at least one or more of A, B, and C” (or “one or more of A, B, and C”) is intended to be understood to mean any of A, B, or C, or any combination thereof (e.g., A, B, and/or C). As such, disjunctive language is not intended to, nor should it be understood to, imply that a given embodiment requires at least one of A, at least one of B, and at least one of C to each be present.

As used herein, the term “based on” (or similar) is an open-ended term used to describe one or more factors that affect a determination or other action. This term does not foreclose additional factors that may affect a determination or action. For example, a determination may be solely based on the factor(s) listed or based on the factor(s) and one or more additional factors. Thus, if an action A is “based on” B, then B is one factor that affects action A, but this does not foreclose the action A from also being based on one or more other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (meaning having the potential to), rather than the mandatory sense (meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method, comprising:
transmitting, by a mobile tracking device, an RF (radio frequency) signal;
receiving, in response to the RF signal, at the mobile tracking device from a passive tag, a response message including information; and
transmitting, by the mobile tracking device, the information to a network.

2. The computer-implemented method of claim 1, wherein the mobile tracking device is secured to a pallet and the passive tag is secured to goods supported by the pallet.

3. The computer-implemented method of claim 1, wherein the RF signal is unmodulated.

4. The computer-implemented method of claim 1, wherein the RF signal is a modulated RF signal, and wherein the information received from the passive tag is based on one or more commands received by the passive tag from the mobile tracking device in the modulated RF signal.

5. The computer-implemented method of claim 1, wherein the information includes an identifier of the passive tag.

6. The computer-implemented method of claim 1, wherein the information includes sensor data from an onboard sensor of the passive tag.

7. The computer-implemented method of claim 5, wherein the sensor data includes one or more of temperature, humidity, information about presence and/or concentration of gaseous substances, or information about presence and/or concentration of particulate matter.

8. The computer-implemented method of claim 1, wherein the network is one of a wireless personal area network, a wireless local area network, a cellular network, or a satellite network.

9. The computer-implemented method of claim 1, wherein the passive tag is a passive RFID (radio-frequency identification) tag.

10. The computer-implemented method of claim 8, wherein the passive RFID tag converts energy received from the RF signal into electromagnetic RF energy and uses the electromagnetic RF energy to power the RFID tag.

11. A computer-implemented method, comprising:
transmitting, by a mobile tracking device, an RF (radio frequency) signal;
receiving, at a passive tag, the RF signal;
transmitting, by the passive tag in response to the RF signal, a response message including information;
receiving, at the mobile tracking device, the response message including the information; and
transmitting, by the mobile tracking device, the information to a network.

12. The computer-implemented method of claim 11, wherein the mobile tracking device is secured to a pallet and the passive tag is secured to goods supported by the pallet.

13. The computer-implemented method of claim 11, wherein the RF signal is unmodulated.

14. The computer-implemented method of claim 11, wherein the RF signal is a modulated RF signal, and wherein the information received from the passive tag is based on one or more commands received by the passive tag from the mobile tracking device in the modulated RF signal.

15. The computer-implemented method of claim 11, wherein the information includes an identifier of the passive tag.

16. The computer-implemented method of claim 11, wherein the information includes sensor data from an onboard sensor of the passive tag.

17. The computer-implemented method of claim 16, wherein the sensor data includes one or more of temperature, humidity, information about presence and/or concentration of gaseous substances, or information about presence and/or concentration of particulate matter.

18. The computer-implemented method of claim 11, wherein the network is one of a wireless personal area network, a wireless local area network, a cellular network, or a satellite network.

19. The computer-implemented method of claim 11, wherein the passive tag is a passive RFID (radio-frequency identification) tag.

20. The computer-implemented method of claim 19, wherein the passive RFID tag converts energy received from the RF signal into electromagnetic RF energy and uses the electromagnetic RF energy to power the RFID tag.
